(19) United States
(12) Patent Application Publication
(10) Pub. No.: US 2019/0032616 A1
(43) Pub. Date: Jan. 31, 2019

(54) High-Pressure Fuel Pump

(71) Applicant: Continental Automotive GmbH, Hannover (DE)

(72) Inventors: Jörg Bernhardt, Nürnberg (DE); Yavuz Kurt, Roding (DE)

(73) Assignee: Continental Automotive GmbH, Hannover (DE)

(21) Appl. No.: 16/071,874

(22) PCT Filed: Jan. 17, 2017
(86) PCT No.: PCT/EP2017/050860

§ 371 Date: Jul. 20, 2018

(30) Foreign Application Priority Data
Jan. 22, 2016 (DE) 10 2016 200 905.2

(51) Int. Cl. F02M 59/02; F02M 59/48; F04B 1/04; F04B 1/053; F04B 53/16; F04B 53/22

(52) U.S. Cl. CPC F02M 59/027; F02M 59/48; F04B 1/0404; F02M 2200/85; F04B 53/16; F04B 53/22; F04B 1/053

(57) ABSTRACT

In some embodiments, a fuel pump includes: a housing; and a flange for fastening the housing to an engine. The flange includes two mutually separated parts for encompassing one circumferential part-region of the housing with a housing receptacle clearance. Each of the two flange parts includes two flange connection regions disposed along a flange-bisecting axis opposite the housing receptacle clearance. A first flange connection region part includes a planar connection element disposed in a first flange plane and a second flange connection region of the flange part includes a connection element disposed in a second flange plane and projecting beyond the first flange plane. The planar connection element of the flange part engages in a form-fitting manner with the projecting connection element of another flange part. The projecting connection element of the flange part engages in a form-fitting manner with the planar connection element of the other flange part.

### CROSS-REFERENCE TO RELATED APPLICATIONS

This application is a U.S. National Stage Application of International Application No. PCT/EP2017/050860 filed Jan. 17, 2017, which designates the United States of America, and claims priority to DE Application No. 10 2016 200 905.2 filed Jan. 22, 2016, the contents of which are hereby incorporated by reference in their entirety.

### TECHNICAL FIELD

The present disclosure relates to pumps. Various embodiments may include a high-pressure fuel pump for supplying a fuel at high pressure.

### BACKGROUND

High-pressure fuel pumps in fuel injection systems are used to apply a high pressure to a fuel, wherein the pressure is in the range from 250 bar-450 bar in gasoline internal combustion engines and in the range from 1500-3000 bar in diesel internal combustion engines, for example. The greater the pressure which can be generated in the particular fuel, the lower the emissions which arise during the combustion of the fuel in a combustion chamber, this being advantageous in particular against the background of a reduction in emissions being desired to an ever greater extent.

In order for the high pressures to be able to be achieved in the respective fuel the high-pressure fuel pumps mentioned may include a piston pump in which a pump piston is driven by an eccentric shaft. This eccentric shaft herein is mounted in a cylinder head, or in an engine block, respectively, such that the high-pressure fuel pump for contacting the pump piston with the eccentric shaft is fastened to the engine block, or to the cylinder head, respectively.

A flange which is fastened to a housing of the high-pressure fuel pump by means of a weld seam, that is to say in a materially integral manner, is in most instances used for fastening the high-pressure fuel pump. The flange, on account of the weld seam, is fixedly fastened to the housing of the high-pressure fuel pump so that any re-orientation of the flange is no longer possible once the flange has been fastened to the housing of the high-pressure fuel pump.

On account thereof, it is also no longer possible for the high-pressure fuel pump having the flange fastened thereto to be attached in a flexible manner to different cylinder heads or engine blocks, respectively, the installation space available in said cylinder heads or engine blocks potentially being configured so as to differ in terms of shape and size.

### SUMMARY

The teachings of the present disclosure may include various embodiments of a high-pressure fuel pump which is flexible in terms of fastening to a cylinder head or engine block, respectively. For example, some embodiments may include a high-pressure fuel pump (10) for applying high pressure to a fuel, having: a housing (12) for receiving at least one high-pressure generation element (16) for generating the high pressure in the fuel; a flange (14) for fastening the housing (12) to a cylinder head and/or to a motor block of an internal combustion engine; wherein the flange (14) is configured so as to be separate from the housing (12) and has at least two mutually separated flange parts (26) which are configured for encompassing in each case one circumferential part-region (30) of the housing (12) by way of a housing receptacle clearance (44), wherein the flange parts (26) for connecting two flange parts (26) in a form-fitting manner have in each case at least two flange connection regions (28) that are disposed along a flange-bisecting axis (AH) so as to be opposite the housing receptacle clearance (44), wherein a first flange connection region (28) of a flange part (26) has at least one planar connection element (46) that is disposed in a first flange plane (40), and a second flange connection region (28) of the flange part (26) has at least one connection element (50) that is disposed in a second flange plane (41) and projects beyond the first flange plane (40), wherein the planar connection element (46) of the flange part (26) is configured for engaging in a form-fitting manner with the projecting connection element (50) of another flange part (26), and wherein the projecting connection element (50) of the flange part (26) is configured for engaging in a form-fitting manner with the planar connection element (46) of the other flange part (26).

In some embodiments, the flange parts (26) at least in the flange connection regions (28) are formed from a sheet-metal material (64) that is capable of mechanical forming.

In some embodiments, the at least two flange connection regions (28) of a flange part (26) are configured so as to be mutually identical.

In some embodiments, the at least one connection element (46, 50) of at least one of the flange connection regions (28) is configured as a connection tab (48).

In some embodiments, the connection tab (48) is configured as a bridge element (58) having a bridge part-region (60A) that is disposed in the first flange plane (40), and a bridge part-region (60B) that is disposed outside the first flange plane (40), in particular in the second flange plane (41), and/or in that the connection tab (48) is formed from a sheet-metal material (64) that is capable of mechanical forming.

In some embodiments, the at least one projecting connection element (50) of one of the flange connection regions (28) is configured as a duct elevation (52) for at least partially receiving a connection tab (48).

In some embodiments, the duct elevation (52) extends so as to be parallel with the flange-bisecting axis (AH) across the entire flange connection region (28), or in that the duct elevation (52) rises so as to be parallel with the flange-bisecting axis (AH) and centric in the flange connection region (28) and is flanked in each case by one plane region (54) of the flange part (26) that is disposed in the first flange plane (40).

In some embodiments, the flange connection region (28) along a longitudinal axis (AL) of the flange part (26) that is aligned so as to be substantially perpendicular to the flange-bisecting axis (AH), in front of or behind the duct elevation (52), has a clearance for shoehorning and/or levering in a part-region (62) of a connection tab (48).

In some embodiments, at least one connection element (50) that is disposed in the second flange plane (41) and projects beyond the first flange plane (40) is additionally disposed at a flange connection region (28) beside a planar connection element (46) that is disposed in the first flange plane (40), wherein, in particular when two additional connection elements (50) that project beyond the first flange plane (40) are provided, the planar connection element (54) that is disposed in the first flange plane (40) is disposed between the connection elements (50) that project beyond the first flange plane (40).

In some embodiments, the housing (12) has an encircling protrusion (34) on which the at least two flange parts (26) are supported, or in that the housing (12) has a groove which is configured so as to be in each case complementary to one support region (36) of the respective flange part (26) and in which the respective support region (36) of the respectively assigned flange part (26) engages.

### BRIEF DESCRIPTION OF THE DRAWINGS

Various design embodiments of the teachings herein are explained in more detail below by means of the appended drawings. In the drawings:

FIG. 1 shows a perspective illustration of a high-pressure fuel pump having a flange, constructed from two mutually separated flange parts, for fastening the high-pressure fuel pump to a cylinder head, or to an engine block, according to the teachings of the present disclosure;

FIG. 2 shows a perspective illustration of one embodiment of the two flange parts from FIG. 1, according to the teachings of the present disclosure;

FIG. 3 shows a perspective illustration of one embodiment of the two flange parts from FIG. 1, according to the teachings of the present disclosure;

FIG. 4 shows a sectional illustration through a joint region of the flange parts in FIG. 1, according to the teachings of the present disclosure;

FIG. 5 shows a sectional illustration through the line A-A in FIG. 4;

FIG. 6 shows a perspective illustration of one embodiment of the two flange parts from FIG. 1, according to the teachings of the present disclosure;

FIG. 7 shows a perspective illustration of one embodiment of the two flange parts from FIG. 1, according to the teachings of the present disclosure;

FIG. 8 shows a sectional illustration through the joint region of the two flange parts in FIG. 1, according to the teachings of the present disclosure; and

FIG. 9 shows a sectional illustration through the joint region of the two flange parts in FIG. 1, according to the teachings of the present disclosure.

### DETAILED DESCRIPTION

In some embodiments, a high-pressure fuel pump for applying high pressure to a fuel has a housing for receiving at least one high-pressure generation element for generating the high pressure in the fuel, and a flange for fastening the housing to a cylinder head and/or to an engine block of an internal combustion engine. The flange is configured so as to be separate from the housing and has at least two mutually separated flange parts which are configured for encompassing in each case one circumferential part-region of the housing by way of a housing receptacle clearance, wherein the flange parts for connecting two flange parts in a form-fitting manner have in each case at least two flange connection regions that are disposed along a flange-bisecting axis so as to be opposite the housing receptacle clearance. A first flange connection region of a flange part has at least one planar connection element that is disposed in a first flange plane, and a second flange connection region of the flange part has at least one connection element that is disposed in a second flange plane and projects beyond the first flange plane. The planar connection element of the flange part is configured for engaging in a form-fitting manner with the projecting connection element of another flange part, and the projecting connection element of the flange part is configured for engaging in a form-fitting manner with the planar connection element of the other flange part. In some embodiments, the two flange parts are configured so as to be mutually identical and can therefore be produced in a cost-effective manner according to the common parts strategy.

In some embodiments, a free orientation of the high-pressure fuel pump is possible on account of the flange having at least two mutually separated flange parts which in each case encompass only a circumferential part-region of the housing, wherein the requirements set for the flange, such as holding down the high-pressure fuel pump without excessive breathing and fixing said high-pressure fuel pump, are nevertheless met. A high stability of the entire arrangement and a tight fastening of the high-pressure fuel pump can be achieved on account of the flange connection regions of the flange parts to be mutually connected engaging in one another in a form-fitting manner. Since an integral flange cannot thus be simply pushed onto the housing from above and be connected in a form-fitting manner to the housing due to interfering contours such as, for example, fluid connectors on the housing of the pump, the approach by way of two parts, in which two flange parts engage in one another in a form-fitting manner, represents a stable and flexible alternative to a welded flange.

In some embodiments, the first flange plane and the second flange plane herein are disposed so as to be mutually parallel yet mutually spaced apart. The flange-bisecting axis is to be understood as the axis along which the flange is divided into the two mutually separated flange parts. Each flange part which is substantially configured for implementing, besides the flange-connection regions, also a fastening region for securely fastening the respective flange part to the cylinder head, or to the engine block, respectively, of the internal combustion engine, extends further along a longitudinal axis which is disposed so as to be substantially perpendicular to the flange-bisecting axis. In some embodiments, for reasons of cost, the flange overall may be configured so as to be substantially elliptic, thus each flange part configuring substantially a half-ellipse. However, the division of the flange into the flange parts can also be performed diagonally or along the longitudinal axis of the flange, or in any other arbitrary form.

In some embodiments, the flange parts at least in the flange connection regions may be formed from a sheet-metal material that is capable of mechanical forming. The flange parts, and in particular the flange connection regions on the flange parts, on account thereof can be produced in a particularly cost-effective and simple manner. In some embodiments, the at least two flange connection regions of a flange part are configured so as to be mutually identical. The flange part on account thereof can be produced in a particularly simple manner by way of identically shaped tools.

In some embodiments, the at least one connection element of at least one of the flange connection regions is configured as a connection tab. Tab-shaped design embodiments for connecting a plurality of elements can be produced in a particularly simple manner and therefore offer a cost-effective potential for providing a connection assembly. In some embodiments, the connection tab is configured as a bridge element having a bridge part-region that is disposed in the first flange plane, and a bridge part-region that is disposed outside the first flange plane, in particular in the second flange plane. A connection tab configured in such a manner can be easily levered into a clearing of a counterpart, for example, and by being levered into place thus forms the form-fit in a simple manner.

In some embodiments, the connection tab may be formed from a sheet-metal material that is capable of mechanical forming. On account thereof, a simply configured connection tab can be provided, for example, said connection tab upon joining the two flange parts being able to be mechanically formed in order to prevent the two flange parts being released. In some embodiments, the at least one projecting connection element of one of the flange connection regions may be configured as a duct elevation for at least partially receiving a connection tab. A connection tab that is disposed on one of the two flange parts, simply by being pushed into the duct elevation of the other flange part, can thus lead to the form-fit between the two flange parts.

In some embodiments, the duct elevation extends so as to be parallel with the flange-bisecting axis across the entire flange connection region, and thus offers a relatively wide plug-in face for an assigned connection tab and thus a secure connection possibility for connecting the two flange parts. In some embodiments, the duct elevation rises so as to be parallel with the flange-bisecting axis and centric in the flange connection region and to be flanked in each case by one plane region of the flange part that is disposed in the flange plane. It is possible for the two plane regions beside the duct elevation in this instance to likewise interact with assigned connection elements of the other flange part in order for a form-fitting connection of the two flange parts to be thus implemented.

In some embodiments, the flange connection region along a longitudinal axis of the flange part is aligned so as to be substantially perpendicular to the flange-bisecting axis, in front of or behind the duct elevation, and may have a clearance for shoehorning and/or levering in a part-region of a connection tab. There is thus the possibility for a connection tab of one of the two flange parts, for example after the two flange parts to be connected have been joined in a form-fitting manner, to be formed and to be shoehorned into said provided clearance of the assigned flange part in order to prevent the two flange parts being released. In some embodiments, such a connection tab, when the latter is shaped in a corresponding manner, may be levered into such a clearance and for the fixed connection thus to be implemented already when the form-fit is established.

In some embodiments, at least one connection element that projects beyond the first flange plane is disposed at a flange connection region beside a planar connection element that is disposed in the first flange plane, so as implement two interacting regions within the respective flange connection region when the two flange parts are joined, and to thus design the connection of the two flange parts so as to be more secure. To this end two additional connection elements may be disposed in the second flange plane and project beyond the first flange plane, wherein the planar connection element that is disposed in the first flange plane is disposed between the two connection elements that project beyond the first flange plane. On account thereof, a secure form-fitting connection between the two flange parts to be joined can also be implemented here by way of a lock-and-key principle.

Overall, the shape and the number of the connection elements in the flange connection regions can vary. For example, in some embodiments, the connection elements may be configured as connection tabs and for the lengths of the respective connection tabs along the longitudinal axis herein also to be designed dissimilarly. In some embodiments, at least one of the connection tabs to be formed into the assigned flange part, for example into a provided clearance. However, it is also possible for all of the connection tabs to have identical lengths along the longitudinal axis of the respective flange part.

The flange that is formed from the at least two flange parts in the fastened state of the housing may completely enclose a housing circumference of the housing. A particularly secure fastening of the housing to the cylinder head, or the engine block, respectively, can be achieved on account thereof.

In some embodiments, the housing includes an encircling protrusion on which the at least two flange parts are supported. In some embodiments, the housing includes a groove which is configured so as to be in each case complementary to one portion region of the at least two flange parts and into which the respective portion region of the respectively assigned flange part engages. A secure fastening of the flange to the housing is provided by both described embodiments, and the fastening force for holding down the housing is particularly well transmitted from the flange to the housing.

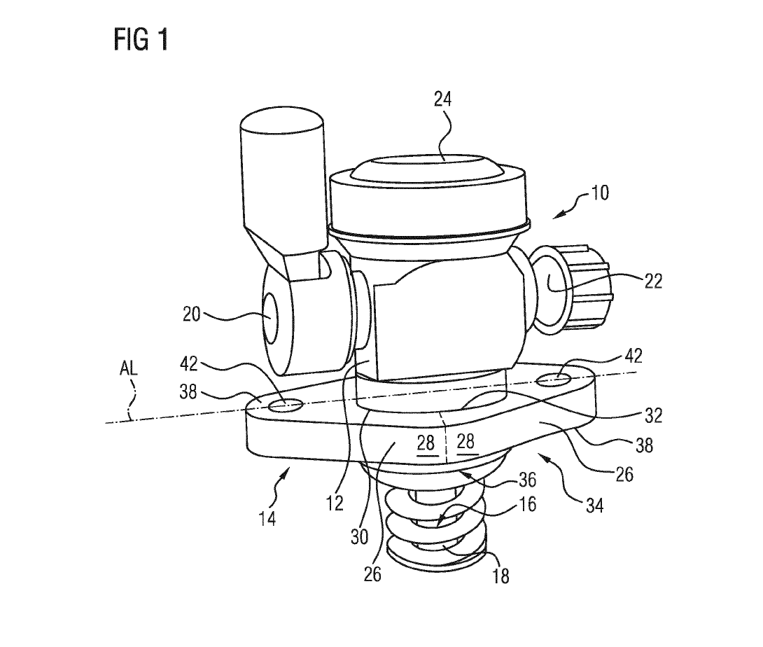

FIG. 1 shows a perspective illustration of a high-pressure fuel pump 10 which has a housing 12 and a flange 14.

In some embodiments, at least one high-pressure generation element 16 such as, for example, a pump piston 18, is accommodated in the housing 12. An inlet 20, an outlet 22, and a damper 24 are furthermore fastened to the housing 12. The high-pressure fuel pump 10 in FIG. 1 is only an exemplary illustration of a high-pressure fuel pump 10; other high-pressure fuel pumps 10 having housings 12 of different designs and further connectors or elements can also be used.

In order for the housing 12 to be able to be fastened to, for example, a cylinder head, or to an engine block, respectively, of an internal combustion engine such that a drive element such as, for example, an eccentric shaft can drive the pump piston 18 in a translatory movement, the flange 14 which holds down the housing 12 on the cylinder head, or the engine block, respectively, is provided. This is because high-pressure fuel pumps 10, for example gasoline/diesel high-pressure pumps such as, for instance, single-piston pumps, require the flange 14 for fixing in order to be assembled on the cylinder head or engine block, respectively. Said flange 14 on the high-pressure fuel pump 10 is normally fabricated as an integral flange and as a separate component, and in the assembly of the pump is welded to the housing 12. This means that said flange 14 is normally attached to the high-pressure fuel pump 10 in a materially integral manner by means of a weld seam.

However, the weld seam does not permit any subsequent reorientation of the flange 14, or of the high-pressure fuel pump 10, respectively, this in a bidding phase potentially leading to more problems in terms of time-critical prototype constructions, for example. A subsequent reorientation of the high-pressure fuel pump 10 can optionally also be useful in installation space experiments. The flexibility and thus the orientation potentials to date are thus limited only to the predefined high-pressure fuel pump 10.

Therefore, the use of a flange 14 which can be connected to the housing 12 in a form-fitting manner would be more favorable than a materially integral connection of the flange 14 to the housing 12. However, since the accessibility to the housing 12, in particular in the installation direction from above, often does not exist, it is often not possible for a complete flange 14 to be connected to the housing 12 in a form-fitting manner.

If, instead, the flange 14 is embodied in two parts, wherein the two flange parts 26 are also mutually separate in the installed state, and is then plug-fitted into a groove, for example, the two flange parts 26 must be supported at the top and the bottom on the two parallel groove faces. This causes significant stresses in the component which can lead to deformations of, for example, highly precise guide elements. This method is therefore not very suitable for the application, or suitable only to a limited extent, respectively. The only suitable solution to date for connecting the flange 14 to the housing 12 was therefore a materially integral connection.

In some embodiments, a flange 14 which has a divided flange concept having at least two mutually separated flange parts 26 is disposed on the high-pressure fuel pump 10 according to FIG. 1, said divided flange concept permitting a free orientation of the high-pressure fuel pump 10 and nevertheless meeting the requirements set for the flange 14, such as for example holding down the high-pressure fuel pump 10. Therefore, the two flange parts 26 are disposed so as not to be entirely mutually separated but are configured such that said two flange parts 26 engage in one another in flange connection regions 28 that are especially provided to this end and thus establish a form-fit. There is also the possibility for more than only two flange parts 26 to be connected in a form-fitting manner so as to form the entire flange 14.

The two flange parts 26 of the flange 14 can therefore either be fastened to the housing 12 of the high-pressure fuel pump 10 by welding, for example, when the pump is assembled and can be shipped to the customer in this way, or it is alternatively also possible for said two flange parts 26 to be sent along to the customer as individual parts such that said customer can place the flange 14 onto the housing 12 of the high-pressure fuel pump 10 directly on the engine block. The handling of the high-pressure fuel pump 10, for example during the assembly or the transportation, respectively, can therefore take place without the flange 14. The handling by virtue of the unmodified interfaces on the housing 12 of the high-pressure fuel pump 10 is thus significantly simplified. This results in fewer internal variants, less complexity, and higher cost savings. Theoretically, materially integral joining, for example the welding process, can also be dispensed with, this leading to further cost savings.

Pump constructions using a previously non-existent orientation of the flange 14 on a housing 12 of the high-pressure fuel pump 10, for example during the bidding phase for new projects in which sample pumps have to be constructed comparatively frequently are thus producible in a very simple manner and in a short time frame. This is because the welding of the flange 14 in a new orientation is in most instances complex and associated with the procurement of new devices, for example, this now being able to be dispensed with. Overall, a comparatively high flexibility in terms of the hole spacing and of the equalization of alignment errors and of the potential solutions of the overall flange design in terms of construction results.

Accordingly, the flange in FIG. 1 has two flange parts 26 which are mutually separated and which by way of an overlap or of a mutual form-fitting engagement, respectively, in each case in two flange connection regions 28 are connected to an overall flange 14. Each flange part 26 herein encompasses in each case one circumferential part-region 30 of the housing 12. The two flange parts 26 as the overall flange 14 collectively encompass the housing circumference 32 of the housing 12 in a largely complete manner. In some embodiments, the overall flange 14 may encompass the housing only in part-regions.

The housing 12 of the present embodiment comprises an encircling protrusion 34, a collar, on which the two flange parts 26 can be supported, specifically by way of a support region 36 which bears on the protrusion 34. In some embodiments, a groove may be on the housing 12, said groove being configured so as to be complementary to the respective support region 36 of the flange part 26 such that the flange parts 26 can engage in the groove so as to be able to apply a fastening force to the housing 12. The correct position of the two flange parts 26 on the housing 12 of the high-pressure fuel pump 10 can be established, for example, by way of positioning pins or other markings.

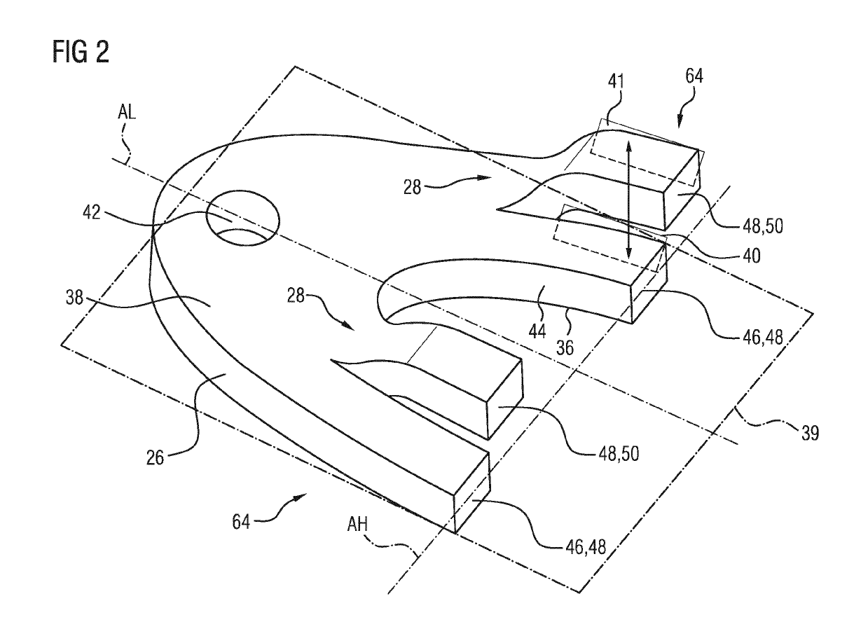

One of the two flange parts 26 from FIG. 1 is illustrated in a first embodiment in a perspective illustration in FIG. 2. The flange part 26 has a fastening region 38 by way of which the flange part 26 can be fastened to the engine block, or the cylinder head, respectively, wherein the fastening region 38 overall defines a flange main plane 39 of the flange part 26. Accordingly, the largest part of the flange part 26 is configured so as to lie in the flange main plane 39, as can be seen in FIG. 2.

In order to be able to fasten the flange part 26 to the engine block, or the cylinder head, respectively, a screw hole 42 is provided specifically on an end of the flange part 26. The flange part 26 at an opposite end of the flange part 26 has a housing receptacle clearance 44 by way of which the flange part 26 encompasses the housing 12 on a circumferential part-region 30 of the housing circumference 32.

The flange 14 along a flange-bisecting axis AH is subdivided into the two flange parts 26. Two flange connection regions 28 are disposed along the flange-bisecting axis AH on two sides of the flange part 26, that is to say so as to be opposite in relation to the housing receptacle clearance 44, on the flange part 26. The two flange connection regions 28 of the flange part 26 in the present embodiment are configured so as to be mutually identical, this having advantages with a view to the production of the flange part 26. However, it is also possible for the two flange connection regions 28 to be configured dissimilarly, as will be shown hereunder by means of further embodiments.

In the embodiment shown in FIG. 2, both flange connection regions 28 have a planar connection element 46, in the form of a connection tab 48, that is disposed in a first flange plane 40, and a connection element 50 that is disposed in a second flange plane 41 and projects beyond the first flange plane 40, said connection element 50 in the present embodiment likewise being configured as a connection tab 48. The first flange plane 40 and the second flange plane 41 herein are disposed so as to be mutually parallel but spaced apart, and also do not lie in the flange main plane 39 which is defined by the fastening region 38. In some embodiments, the flange main plane 39 and the first flange plane 40 may coincide.

In some embodiments, both flange parts 26 which form the entire flange 14 to be configured in a mutually identical manner. Therefore, if a flange part 26 in the embodiment according to FIG. 2 is brought to connect to itself, the projecting connection elements 50 are pushed over the planar connection elements 46 of the other flange part, or the planar connection elements 46 of the one flange part 26 are pushed below the projecting connection elements 50 of the other flange part 26. Thus results a form-fitting mutual engagement of the planar connection elements 46 and of the projecting connection elements 50, and thus a secure connection of the two separately embodied flange parts 26. The particularly secure connection of the two flange parts 26 results from in each case two regions, or elements, respectively, being available for the form-fitting connection in each flange connection region 28.

In some embodiments, the two flange parts 26 of the flange 14 are geometrically identical so as to thus facilitate the assembly, since there is no risk of confusion, and so as to minimize the unit costs as much as possible since a lower part price is achieved at higher volumes. In some embodiments, the two flange parts 26 of the flange 14 may be fabricated such that said two flange parts 26 connect to one another in a form-fitting manner by means of a plurality of part-regions, such as results, for example, in FIG. 2 by way of the two connection elements 46, 50 in each flange connection region 28.

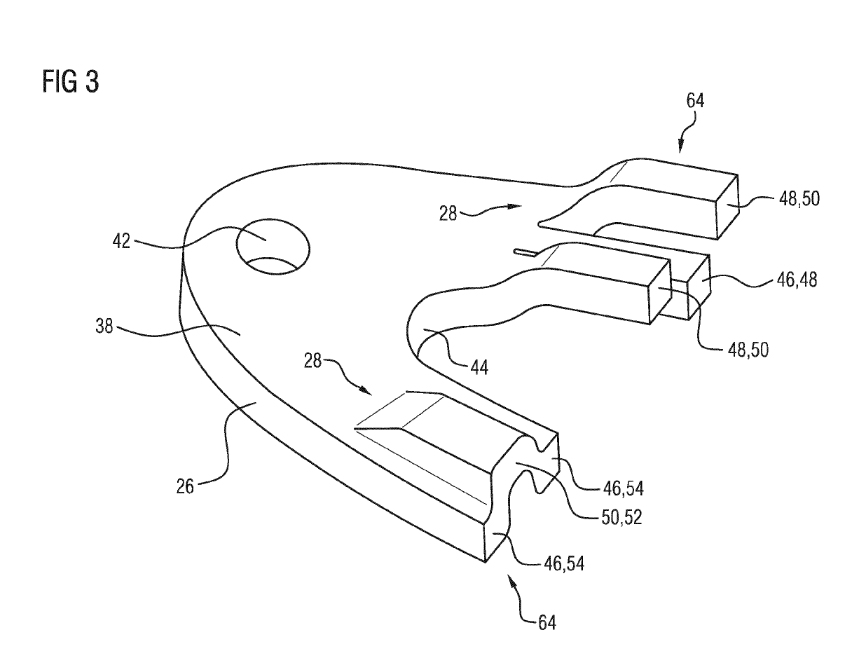

FIG. 3 shows a perspective illustration of a second embodiment of the flange parts 26 from FIG. 1. The two flange connection regions 28 of the flange part 26 herein are not configured in an identical manner but have different shapes. One of the two flange connection regions 28 herein has three connection elements 46, 50, specifically a planar connection element 46 which is flanked by two projecting connection elements 50, wherein all of the connections elements are configured as connection tabs 48. The connection tabs 48 herein along a longitudinal axis AL of the flange part 26 that is aligned so as to be perpendicular to the flange-bisecting axis AH have identical lengths.

The connection element 50 in the further flange connection region of the flange part 26 is not configured in the form of a connection tab 48 but as a duct elevation 52 which rises so as to be parallel with the flange-bisecting axis AH and centric in the flange connection region 28 and is flanked by in each case one plane region 54 of the flange part 26 that is disposed in the first flange plane 40. When two flange parts 26 which are configured as is shown in FIG. 3 are being connected, the planar connection element 46 of the one flange connection region 28 is pushed under the duct elevation 52 of the other flange connection region 28, and the two projecting connection tabs 48 of the one flange connection region 28 are pushed onto the two plane regions 54 of the other flange connection region 28. Therefore, there are three elements for the form-fitting connection available in each flange connection region 28. A strong form-fit of the two flange parts 26 can be achieved on account thereof.

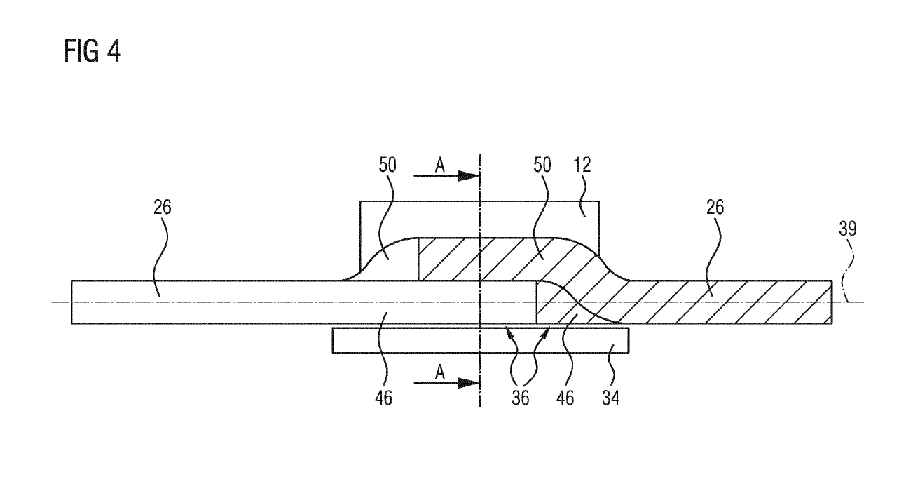

FIG. 4 shows a sectional illustration through the region in which the two flange parts 26 are interconnected on the housing 12. A first flange part 26 is illustrated with hatched lines herein, said first flange part 26 being connected to a second flange part 26 in a form-fitting manner, said second flange part 26 not being hatched. It can be seen how the projecting connection element 50 of the one flange part 26 engages across the planar connection element 46 of the other flange part 26, thus establishing the form-fitting connection. Such a connection can be established in that two connection tabs 48, according to the embodiment illustrated in FIG. 2, engage in one another; however, it is also possible for such a connection profile to be established when, according to FIG. 3, a connection tab 48 and a duct elevation 52 engage in one another.

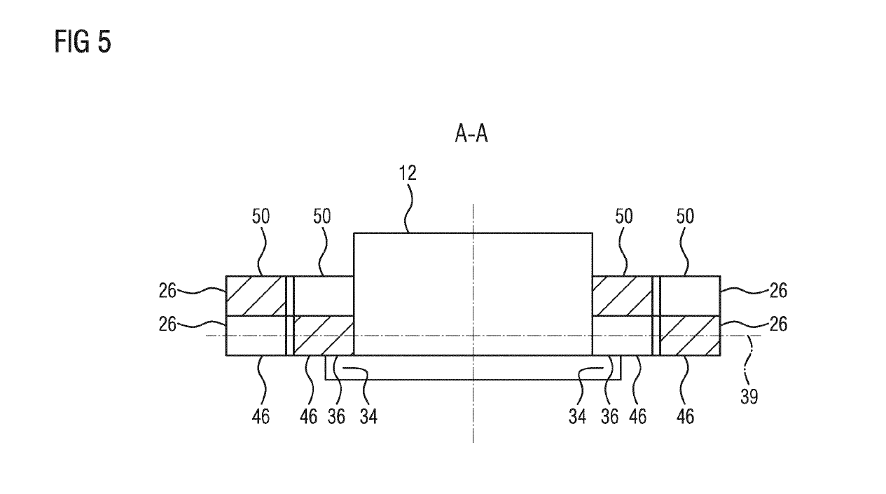

FIG. 5 shows a sectional illustration through the line A-A from FIG. 4 onto the two flange connection regions 28 of a connection embodiment according to FIG. 2.

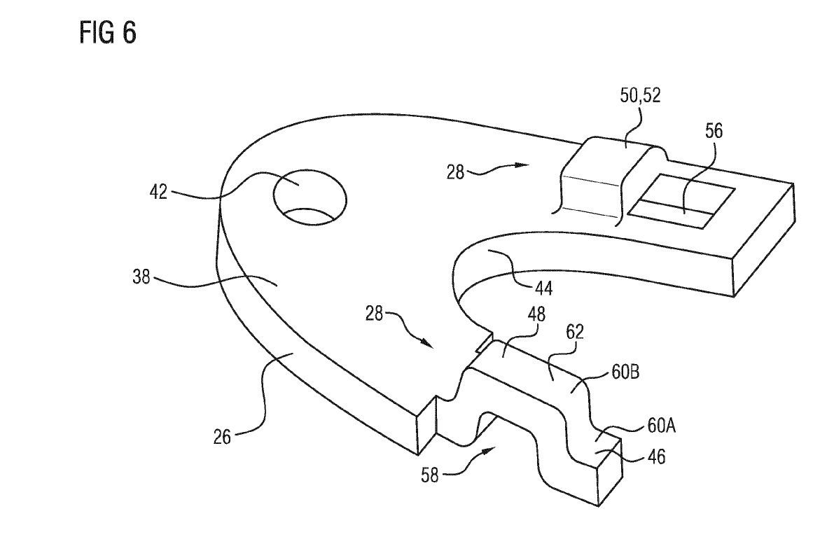

FIG. 6 shows a perspective illustration of a third embodiment of one of the two flange parts 26, wherein the two flange connection regions 28 are also embodied dissimilarly here. A duct elevation is again provided in the one flange connection region 28, wherein a clearance 56 is disposed along the longitudinal axis AL in front of the duct elevation 52 when viewed from the flange-bisecting axis AH.

A connection tab 48 is again provided in the other flange connection region 28, said connection tab 48 here being configured as a bridge element 58 and to this end having a bridge part-region 60A that is disposed in the first flange plane 40, and a bridge part-region 60B that is disposed outside the first flange plane 40. When two flange parts 26 that are configured according to FIG. 6 are interconnected, the bridge element 48 can be simply levered into the clearance 56 such that a part-region 62 of the connection tab 48 that is configured as a bridge element 58 is received by the clearance 56. In order to enable a stable connection of two flange parts 26, the duct elevation 52 is configured such that the latter extends so as to be parallel with the flange-bisecting axis AH across the entire flange connection region 28.

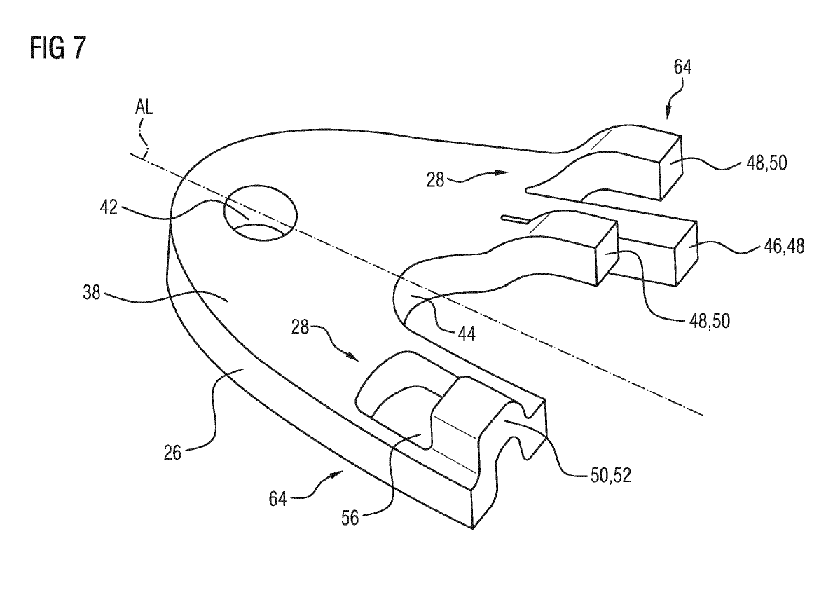

FIG. 7 shows a perspective illustration of a fourth embodiment of the flange parts 26, wherein a duct elevation 52 is again provided in a flange connection region 28, and the connection tabs 48 are provided in the other flange connection region 28, wherein a connection tab 48 is disposed in the first flange plane 40, and the other two connection tabs 48 are disposed outside the first flange plane 40. A clearance 56 is again provided along the longitudinal axis AL behind the duct elevation 52, when viewed from the flange-bisecting axis AH. The planar connection tab 48 in the first flange plane 40 along the longitudinal axis AL is configured so as to be longer than the other projecting connection tabs 48, said planar connection tab 48, once the latter has engaged in the duct elevation 52, therefore being able to be mechanically bent inward into the clearance 56 so as to thus implement a secure connection of the two flange parts 26.

In order to in particular be able to enable mechanical forming in at least one flange connection region 28, the flange parts 26 at least in the flange connection regions 28 are formed from a sheet-metal material 64 that is capable of mechanical forming. In the present embodiment according to FIG. 7, at least the planar connection tab 48 may be formed from this sheet-metal material 64 that is capable of mechanical forming.

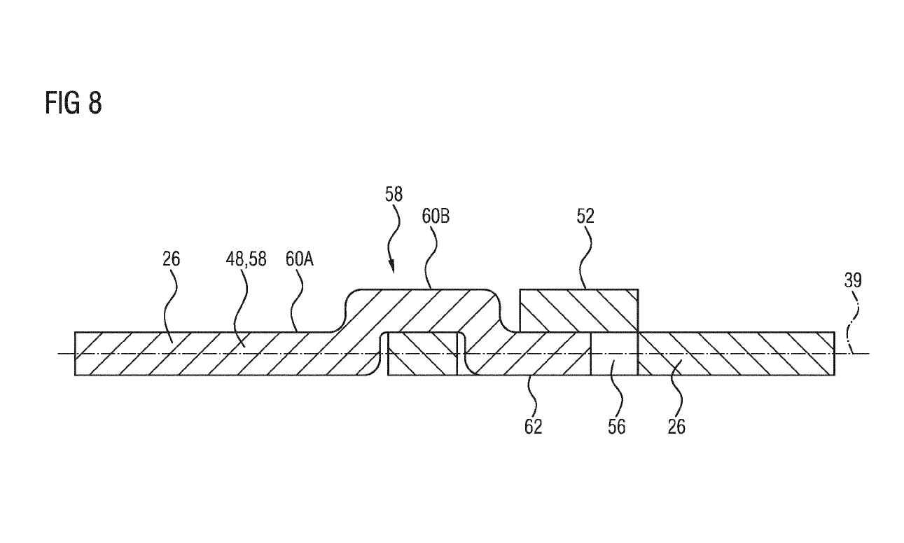

FIG. 8 shows a sectional illustration through the region in which the two flange parts 26 are interconnected, wherein the two flange parts 26 are designed according to FIG. 6. It can be seen that the connection tab 48 of the one flange connection region 28 is simply levered into the clearance 56 of the other flange connection region 28.

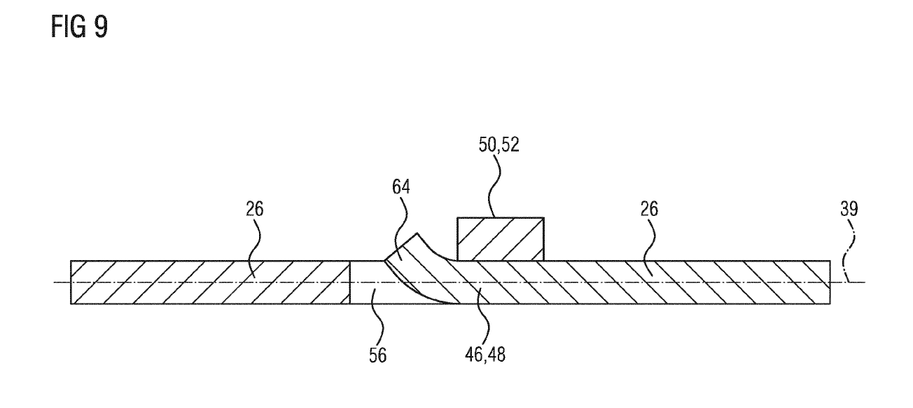

FIG. 9 shows a sectional illustration through the region in which the two flange parts 26 according to the embodiment that is illustrated in FIG. 7 are interconnected, wherein the central connection tab 48 is bent into the clearance 56.

Accordingly, one or a plurality of part-regions 62 of the flange 14 according to the embodiments which are shown in FIG. 6 to FIG. 9 can be formed after the two flange parts 26 have been joined in a form-fitting manner so as to prevent the two flange parts 26 being released. Alternatively, this step can also be dispensed with in that the components in geometric terms are shaped such that said components are already plug-fitted to one another in a form-fitting manner and are already interconnected herein, specifically by joining by way of levering, this being show in FIG. 8.

What is claimed is:

1. A high-pressure fuel pump comprising:
a housing for a high-pressure generation element; and
a flange for fastening the housing to a cylinder head and/or to a motor block of an internal combustion engine;
wherein the flange includes two mutually separated flange parts configured for encompassing in each case one circumferential part-region of the housing by way of a housing receptacle clearance;
each of the two-flange parts includes two flange connection regions disposed along a flange-bisecting axis opposite the housing receptacle clearance;
a first flange connection region of a flange part includes a planar connection element disposed in a first flange plane, and a second flange connection region of the flange part includes a connection element disposed in a second flange plane and projecting beyond the first flange plane;
the planar connection element of the flange part engages in a form-fitting manner with the projecting connection element of another flange part; and
the projecting connection element of the flange part engages in a form-fitting manner with the planar connection element of the other flange part.

2. The high-pressure fuel pump as claimed in claim 1, wherein the flange parts, at least in the flange connection regions, comprise a sheet-metal material capable of mechanical forming.

3. The high-pressure fuel pump as claimed in claim 1, wherein the two flange connection regions of a flange part are configured so as to be mutually identical.

4. The high-pressure fuel pump as claimed in claim 1, wherein the connection element of at least one of the flange connection regions comprises a connection tab.

5. The high-pressure fuel pump as claimed in claim 4, wherein the connection tab comprises a bridge element with:
a first bridge part-region disposed in the first flange plane; and
a second bridge part-region disposed outside the first flange plane.

6. The high-pressure fuel pump as claimed in claim 1, wherein the projecting connection element of one of the flange connection regions comprises a duct elevation for at least partially receiving a connection tab.

7. The high-pressure fuel pump as claimed in claim 6, wherein the duct elevation extends parallel with the flange-bisecting axis across the entire flange connection region and is flanked by one plane region of the flange part disposed in the first flange plane.

8. The high-pressure fuel pump as claimed in claim 6, wherein the flange connection region along a longitudinal axis of the flange part aligned so as to be substantially perpendicular to the flange-bisecting axis, in front of or behind the duct elevation, and has a clearance for shoehorning and/or levering in a part-region of a connection tab.

9. The high-pressure fuel pump as claimed in claim 1, wherein:
at least one connection element disposed in the second flange plane projects beyond the first flange plane and is additionally disposed at a flange connection region beside a planar connection element disposed in the first flange plane (40);
two additional connection elements project beyond the first flange plane; and
the planar connection element disposed in the first flange plane is disposed between the two additional connection elements.

10. The high-pressure fuel pump as claimed in claim 1, wherein the housing comprises an encircling protrusion on which the two flange parts are supported.

11. The high-pressure fuel pump as claimed in claim 6, wherein the duct elevation rises so as to be parallel with the flange-bisecting axis and centric in the flange connection region and is flanked by one plane region of the flange part that is disposed in the first flange plane.

12. The high-pressure fuel pump as claimed in claim 1, wherein the housing includes a groove complementary to one support region of the respective flange part and in which the respective support region of the respectively assigned flange part engages.
